(19) United States
(12) Patent Application Publication
(10) Pub. No.: US 2025/0330256 A1
(43) Pub. Date: Oct. 23, 2025

(54) METHOD AND APPARATUS FOR MANAGING RADIO BROADCAST DATABASE AND IDENTIFYING RADIO BROADCASTING AUDIO SOURCE

(71) Applicants: Hyundai Motor Company, Seoul (KR); Kia Corporation, Seoul (KR)

(72) Inventors: Ji Hun Lim, Gunpo-Si (KR); Jae Kyu Yu, Hwaseong-Si (KR)

(21) Appl. No.: 18/963,391

(22) Filed: Nov. 27, 2024

(30) Foreign Application Priority Data
Apr. 18, 2024 (KR) 10-2024-0052313

(51) Int. Cl. H04H 20/42; H04H 20/71; H04H 20/86

(52) U.S. Cl. CPC H04H 20/42; H04H 20/71; H04H 20/86

(57) ABSTRACT

An apparatus for managing radio broadcast database includes a first broadcast setting unit configured to set a frequency of a first broadcast using a first tuner, a second broadcast setting unit configured to set a frequency of a second broadcast of which broadcast information exists, using a second tuner, an audio signal comparison unit configured to receive a first audio signal of the first broadcast and a second audio signal of the second broadcast, and check whether the first audio signal and the second audio signal are similar to each other, and a broadcast information provision unit configured to acquire second broadcast information related to the second broadcast and store the second broadcast information as first broadcast information related to the first broadcast in a radio broadcast database, if it is determined that the first audio signal and the second audio signal are similar to each other.

### CROSS-REFERENCE TO RELATED APPLICATIONS

The application claims priority to Korean Patent Application No. 10-2024-0052313, filed Apr. 18, 2024, the entire contents of which is incorporated herein by reference in its entirety.

### TECHNICAL FIELD

The present disclosure relates to a method and apparatus for managing radio broadcast database by using comparison of radio broadcasting audio source.

### BACKGROUND

The content to be described below simply provides only background information related to the present example and does not constitute the related art.

In some countries, radio broadcasts are received using an RDS (Radio Data System) which transmits digital information on FM (Frequency Modulation) frequencies or DAB (Digital Audio Broadcasting) that is a digital radio technology, and a name of the broadcast may be found out from data acquired from an RDS or DAB broadcast signal.

However, since the RDS and the DAB are not currently supported and only analog broadcasts are transmitted in some countries (e.g., Korea), names of the broadcasts may not be found out from broadcast signals, unlike the RDS or the DAB.

FIG. 1 shows an example of a diagram showing a radio broadcast list indicating radio broadcast information for each frequency within a vehicle.

In some vehicles, a method in which an administrator wirelessly manually inputs and manages a radio broadcast database (i.e., DB) stored in a radio system of the vehicle and informs the vehicle of a user of radio broadcast information including a broadcast name, a transmission station, a broadcast area, and the like related to a radio broadcast frequency is used.

In a case where the administrator manually manages the radio broadcast database, when the vehicle actually receives a radio broadcast and broadcast information for the radio broadcast is not present in the radio broadcast database within the vehicle, the radio broadcast information may not be provided to a device within the vehicle in some cases.

In this case, a method in which, when the vehicle user reports to the administrator about the absence of broadcast information for a radio broadcast of a specific frequency, the administrator directly visits an area where such a problem has occurred, directly listens to the radio broadcast, ascertains a broadcast to which the radio broadcast of the frequency corresponds, and updates the frequency and the broadcast information in the radio broadcast database within the vehicle is used.

There may be a problem that the administrator listening to several radio broadcasts one by one and finding out broadcast information when updating the radio broadcast database is very inconvenient, and the accuracy of the broadcast information is likely to be degraded.

### SUMMARY

The present disclosure is to provide a method and apparatus for managing radio broadcast database by using comparison of radio broadcasting audio source.

The problems to be solved by the present disclosure are not limited to the above-mentioned problems, and other problems not mentioned may be clearly understood by those skilled in the art from the description below.

An apparatus may comprise: a plurality of tuners comprising a first tuner and a second tuner; at least one signal processor coupled to the plurality of tuners; and memory storing instructions that, when executed by the at least one signal processor, cause the apparatus to: set, using the first tuner, a frequency of a first broadcast, wherein broadcast information of the first broadcast is absent; set, using the second tuner, a frequency of a second broadcast, wherein broadcast information of the second broadcast is provided to the apparatus; receive a first audio signal of the first broadcast and a second audio signal of the second broadcast; determine a correlation between the first audio signal and the second audio signal; and based on a determination that the correlation satisfies a threshold: acquire second broadcast information related to the second broadcast; and update, in a radio broadcast database associated with the apparatus, first broadcast information related to the first broadcast with the second broadcast information.

The instructions, when executed by the at least one signal processor, may cause the apparatus to receive, via a user input, information on the frequency of the first broadcast.

The instructions, when executed by the at least one signal processor, may cause the apparatus to set, based on information on the frequency of the first broadcast not present in the radio broadcast database, the frequency of the second broadcast.

The instructions, when executed by the at least one signal processor, may cause the apparatus to: acquire a frequency of an audible broadcast while changing the frequency set in the first tuner or the second tuner; and set, based on information related to the frequency of the audible broadcast not present in the radio broadcast database, the frequency of the audible broadcast as the frequency of the first broadcast for the first tuner.

The instructions, when executed by the at least one signal processor, may cause the apparatus to determine a radio broadcast stored in the radio broadcast database to be the second broadcast.

The instructions, when executed by the at least one signal processor, may cause the apparatus to sequentially determine at least one radio broadcast stored in the radio broadcast database to be the second broadcast until a correlation between the first audio signal and an audio signal of one of the at least one radio broadcast satisfies the threshold.

The instructions, when executed by the at least one signal processor, may cause the apparatus to, based on a correlation between the first audio signal and each of audio signals of radio broadcasts stored in the radio broadcast database not satisfying the threshold: access, via a wireless connection, a radio streaming source; sequentially receive, from the radio streaming source, at least one audible radio stream; and determine a correlation between the first audio signal and each of audio signals of the at least one audible radio stream.

The instructions, when executed by the at least one signal processor, cause the apparatus to acquire broadcast information corresponding to a first radio stream from the radio streaming source, and wherein a correlation between the first audio signal and an audio signal of the first radio stream satisfies the threshold.

The instructions, when executed by the at least one signal processor, may cause the apparatus to store, in the radio broadcast database, the first broadcast information in association with the frequency of the second broadcast.

A method performed by an apparatus of a vehicle may comprise: setting, using a first tuner of a plurality of tuners of the apparatus, a frequency of a first broadcast, wherein broadcast information of the first broadcast is absent; setting, using a second tuner of the plurality of tuners of the apparatus, a frequency of a second broadcast, wherein broadcast information of the second broadcast is provided to the apparatus; receiving a first audio signal of the first broadcast and a second audio signal of the second broadcast; determining a correlation between the first audio signal and the second audio signal; and based on a determination that the correlation satisfies a threshold: acquiring second broadcast information related to the second broadcast; and updating, in a radio broadcast database associated with the apparatus, first broadcast information related to the first broadcast with the second broadcast information.

The setting the frequency of the first broadcast may comprise: acquiring a frequency of an audible broadcast while changing the frequency set in the first tuner or the second tuner; and setting, based on information related to the frequency of the audible broadcast not present in the radio broadcast database, the frequency of the audible broadcast as the frequency of the first broadcast for the first tuner.

The setting the frequency of the second broadcast may comprise determining a radio broadcast stored in the radio broadcast database to be the second broadcast.

The setting the frequency of the second broadcast may comprise sequentially determining at least one radio broadcast stored in the radio broadcast database to be the second broadcast until a correlation between the first audio signal and an audio signal of one of the at least one radio broadcast satisfies the threshold.

The setting the frequency of the second broadcast may comprise: based on a correlation between the first audio signal and each of audio signals of radio broadcasts stored in the radio broadcast database not satisfying the threshold: accessing, via a wireless connection, a radio streaming source; sequentially receiving, from the radio streaming source, at least one audible radio stream; and determining a correlation between the first audio signal and each of audio signals of the at least one audible radio stream.

According to an example of the present disclosure, it is possible to improve the accuracy of the radio broadcast database by easily identifying the broadcast information through a comparison of a broadcast frequency of which broadcast information does not exist with other broadcast frequencies and registering the broadcast information in the radio broadcast database without the intervention of an administrator.

Further, with the improvement of the accuracy of the radio broadcast database, it is possible to provide higher-quality radio broadcast information to users who listen to radios in vehicles.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 shows an example of a diagram showing a radio broadcast list indicating radio broadcast information for each frequency within a vehicle.

FIG. 2 shows an example of a block diagram showing a radio broadcast database management device 200 according to an example of the present disclosure.

FIG. 3A shows an example of a flowchart showing a radio broadcast database management method according to an example of the present disclosure.

FIG. 3B shows an example of a flowchart showing a radio broadcast database management method according to another example of the present disclosure.

FIG. 4 shows an example of a block diagram schematically showing an example computing device that may be used to implement the method or device according to examples of the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe examples of the present disclosure, and is not intended to represent the only examples in which the present invention may be practiced.

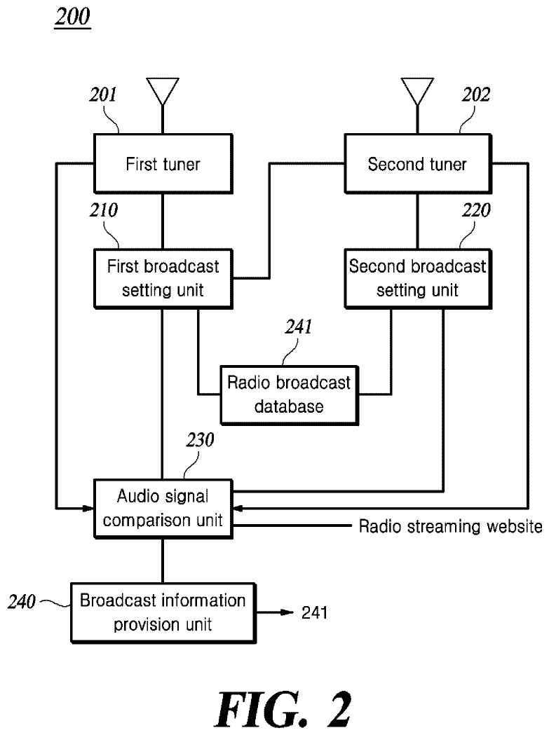

FIG. 2 shows an example of a block diagram showing a radio broadcast database management device 200 according to an example of the present disclosure.

The radio broadcast database management device 200 according to the example of the present disclosure includes a first broadcast setting unit 210 (e.g., a signal processor, a digital signal processor (DSP), etc.), a second broadcast setting unit 220 (e.g., a signal processor, a digital signal processor (DSP), etc.), and an audio signal comparison unit 230 (e.g., an audio correlator), and a broadcast information provision unit 240 (e.g., a display, a wired communication interface, and/or a wireless communication interface, etc.). Not all blocks shown in FIG. 2 may be essential components, and in other examples, some blocks included in the radio broadcast database management device 200 may be added, changed, or deleted. The components shown in FIG. 2 represent functionally distinct elements, and at least one component may be implemented in an integrated form in an actual physical environment.

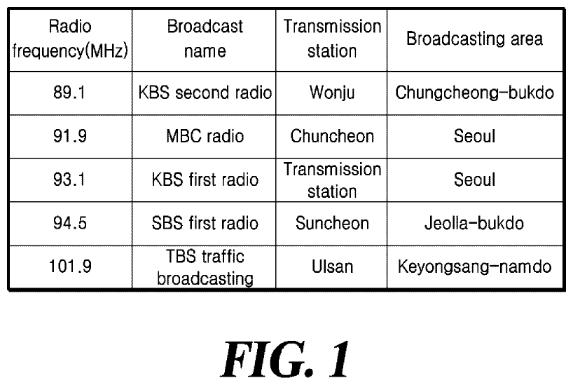

Hereinafter, a radio broadcast database management device 200 according to the present example may be described with reference to FIG. 1 and FIG. 2.

The first broadcast setting unit 210 sets a frequency of a first broadcast using a first tuner 201.

As a first example, the first broadcast setting unit 210 may be implemented to acquire information on the frequency of the first broadcast from a user. In this case, the first broadcast setting unit 210 may be implemented to acquire the information on the frequency of the first broadcast from a user interface and set the frequency of the first broadcast in the first tuner 201.

In this case, the first broadcast setting unit 210 determines whether the information on the frequency of the first broadcast is present in a radio broadcast database 241, and performs control so that the second broadcast setting unit 220 sets a frequency of the second broadcast if the information on the frequency of the first broadcast is not present in the radio broadcast database 241.

Further, as a second example, the first broadcast setting unit 210 may be implemented to automatically set the frequency of the first broadcast in the first tuner 201. In the second example, even if the user does not set the frequency of the first broadcast, the first broadcast setting unit 210 searches for the broadcast frequency and automatically sets the frequency of the first broadcast sequentially if the user presses a predetermined function button (for example, a broadcast database setting button) in a vehicle.

The first broadcast setting unit 210 may be implemented to determine whether or not a broadcast is a listenable broadcast from a radio signal received by the antenna connected to the second tuner 202 (or the first tuner 201) while changing the frequency set using the second tuner 202 (or the first tuner 201), to acquire a frequency of the listenable broadcast, and set the acquired frequency of the listenable broadcast in the first tuner 201 as the frequency of the first broadcast if information related to the acquired frequency of the listenable broadcast is not present in the radio broadcast database 241.

In the second example, the first broadcast setting unit 210 sequentially acquires a frequency of at least one listenable broadcast while automatically changing the frequency of the first tuner 201 or the second tuner 202, searches the radio broadcast database 241 to determine whether the frequency of the listenable broadcast exists as a radio broadcast list in the radio broadcast database 241, and determines whether a broadcast is a listenable broadcast of which the broadcast information may not be identified.

In this case, if the listenable broadcast is the broadcast of which the broadcast information may not be identified, the first broadcast setting unit 210 sets the listenable broadcast as the first broadcast.

The second broadcast setting unit 220 determines the second broadcast of which broadcast information exists and sets the frequency of the second broadcast using the second tuner 202.

The second broadcast setting unit 220 identifies the radio broadcast list stored in the radio broadcast database 241 to recognize the broadcast in the radio broadcast list as the second broadcast of which broadcast information exists, and sequentially sets the frequency of the second broadcast in the radio broadcast list in the second tuner 202.

The audio signal comparison unit 230 receives a first audio signal of the first broadcast from the antenna connected to the first tuner 201, receives a second audio signal of the second broadcast from an antenna connected to the second tuner 202, and checks whether the first audio signal and the second audio signal are similar to each other.

A method of checking whether two audio signals (e.g., the audio signal received from the first tuner 201 and the audio signal received from the second tuner 202) are the same signal may be performed by a method such as correlation analysis, matching algorithms, frequency domain analysis, and/or pattern recognition technology. However, since these technologies depart from the gist of the present disclosure, further details may be omitted.

If the audio signal comparison unit 230 determines that the first audio signal and the second audio signal are not similar to each other, the second broadcast setting unit 220 sequentially sets a frequency of a broadcast in a next radio broadcast list in the radio broadcast database 241 as the frequency of the second broadcast. The second broadcast setting unit 220 sequentially determines at least one radio broadcast stored in the radio broadcast database to be the second broadcast until it is determined that the first audio signal and the second audio signal are similar to each other.

If it is determined that the first audio signal and the second audio signal are similar to each other, the broadcast information provision unit 240 acquires second broadcast information related to the second broadcast from the radio broadcast database 241, and stores the second broadcast information in the radio broadcast database 241 as first broadcast information related to the first broadcast.

The broadcast information provision unit 240 determines at least part of the content of the second broadcast information stored in the list in the radio broadcast database 241 as the first broadcast information, displays and provides the first broadcast information to the user, and stores the first broadcast information as a new radio broadcast list in the radio broadcast database 241 in association with the frequency of the first broadcast.

If the audio signal comparison unit 230 determines that the second audio signal and the first audio signal of the second broadcast in the radio broadcast list of at least one (or all) radio broadcast in the radio broadcast database 241 are not similar to each other, the second broadcast setting unit 220 accesses a radio streaming online website and sequentially identifies listenable radio streams.

If it is determined that the second audio signal of the at least one sequentially determined second broadcast is not similar to the first audio signal, the second broadcast setting unit 220 accesses the radio streaming website to sequentially receive at least one audible radio streaming, and determines whether there is a first radio stream with an audio signal similar to the first audio signal among the audio signals of the audible radio streams.

If an address of at least one radio streaming website is stored in the radio broadcast database 241, the second broadcast setting unit 220 may be implemented to access the address of the at least one radio streaming website stored in the radio broadcast database 241 and acquire the audible radio stream. Further, the second broadcast setting unit 220 may access a preset website to acquire an address of a radio streaming website stored in the preset website, and access the address of the radio streaming website to sequentially acquire listenable radio streams.

The audio signal comparison unit 230 determines whether the first audio signal and the audio signal of the sequentially acquired audible radio streams are similar to each other.

If it is determined that the first audio signal and the audio signal of the audible radio stream (e.g., first radio stream) are similar to each other, the broadcast information provision unit 240 provides broadcast information corresponding to the first radio stream to the user as the first broadcast information and stores the first broadcast information as one list in the radio broadcast database 241 in association with the frequency of the first broadcast.

The broadcast information provision unit 240 may acquire the broadcast information corresponding to the first radio stream from a radio streaming website related to the first radio streaming.

The broadcast information provision unit 240 provides broadcast information of the first radio stream acquired from the radio streaming website to the user as the first broadcast information, and stores the first broadcast information as one list in the radio broadcast database 241 in association with the frequency of the first broadcast.

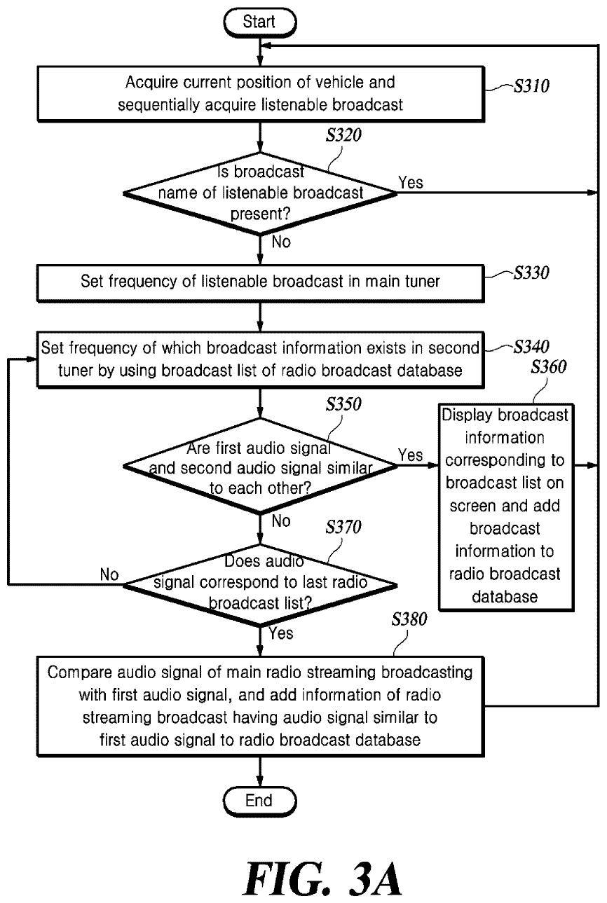

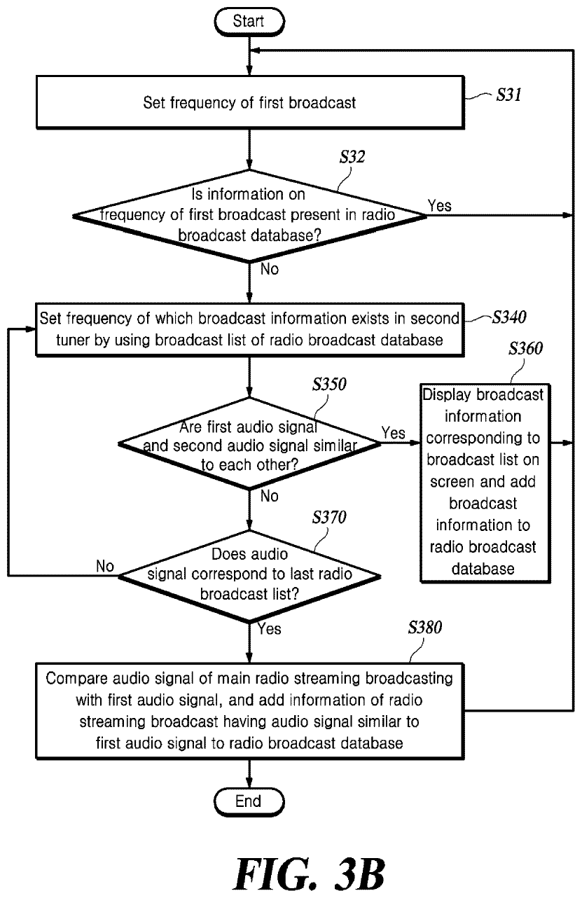

FIG. 3A shows an example of a flowchart showing a radio broadcast database management method according to an example of the present disclosure.

The radio broadcast database management method according to the example of the present disclosure may be performed by the radio broadcast database management device 200.

A process of FIG. 3A may be started by a user that may press a function button for radio broadcast database management (for example, a broadcast database setting button). The process of FIG. 3A may correspond to a process if the first broadcast setting unit 210 is the second example.

In step S3101, the radio broadcast database management device 200 may acquire a current position of the vehicle and sequentially acquire a listenable broadcast for broadcast information collection from a radio signal received through an antenna connected to a second tuner 202, for example, while changing the frequency set by the second tuner 202, which is a sub-tuner. The first broadcast setting unit 210 may sequentially acquire the listenable broadcasts by searching for frequencies, for example, from low frequencies to high frequencies using the second tuner 202.

In step S320, if one listenable broadcast is acquired, the first broadcast setting unit 210 may determine whether broadcast information exists for the acquired listenable broadcast. The first broadcast setting unit 210 may determine whether there is a broadcast name of the listenable broadcast by determining whether a frequency corresponding to the listenable broadcast and broadcast information corresponding thereto are present as the list in the radio broadcast database 241.

If it is determined in step S320 that the broadcast information exists for the listenable broadcast, a method of the present disclosure proceeds to step S310 in which a next listenable broadcast of a current listenable broadcast may be acquired as a new current listenable broadcast. After a plurality of listenable broadcasts are sequentially acquired in order of frequency size in step S310, the method of the present disclosure proceeds to step S320 in which the method sequentially may determine whether or not there are broadcast names of the listenable broadcasts.

In step S320, if it is determined that the broadcast information (e.g., broadcast name of listenable broadcast) does not exist for the acquired listenable broadcast, step S330 may be performed. For example, in step S330, the first broadcast setting unit 210 may set a frequency of the listenable broadcast of which broadcast information does not exist (e.g., the first broadcast) in the first tuner 201, which is a main tuner. If the frequency of the listenable broadcast of which broadcast information does not exist in the first tuner 201, the listenable broadcast may become the first broadcast.

In step S320, if it is determined that the broadcast information (e.g., broadcast name of listenable broadcast) exists for the acquired listenable broadcast, step S310 may be performed.

The second broadcast setting unit 220 may identify the radio broadcast list stored in the radio broadcast database 241 to recognize each broadcast in the radio broadcast list as the second broadcast of which broadcast information exists. In step 340, the second broadcast setting unit 220 may sequentially set the frequency of the second broadcast in the radio broadcast list in the second tuner 202.

The audio signal comparison unit 230 may receive the first audio signal of the first broadcast from the antenna connected to the first tuner 201, receive the second audio signal of the second broadcast from the antenna connected to the second tuner 202. In step S350, the audio signal comparison unit 230 may compare the first audio signal with the second audio signal, and check whether the first audio signal and the second audio signal are similar to each other.

If it is determined in step S350 that the first audio signal and the second audio signal are similar (or identical) to each other, step S360 may be performed. For example, in step S360, the broadcast information provision unit 240 may acquire the second broadcast information of the radio broadcast list related to the second broadcast from the radio broadcast database 241, and display the second broadcast information on a user screen (e.g., user interface, mobility device's screen, etc.) as the first broadcast information related to the first broadcast, and store the first broadcast information in the radio broadcast database 241. For example, the broadcast information provision unit 240 may store (or update) the radio database 241 with the broadcast name based on the region and frequency where the broadcast information provision unit 240 is located.

After step S360 is performed, a method of the present disclosure proceeds to step S310 in which a next listenable broadcast (e.g., listenable broadcast for broadcast information collection) may be sequentially acquired.

If it is determined in step S350 that the first audio signal and the second audio signal are not similar to each other, step S370 may be performed. For example, in step S370, a method of the present disclosure determines whether an audio signal (e.g., a current second audio signal) corresponds to a last radio broadcast list in the radio broadcast database 241.

In step S370, if the audio signal (E.g., the current second audio signal) does not correspond to the last radio broadcast list in the radio broadcast database 241, a method of the present disclosure proceeds to step S340 in which a process of acquiring the next radio broadcast list in the radio broadcast database 241 and setting a frequency of which broadcast information exists in the second tuner 202 is performed.

In step S370, if the current second audio signal corresponds to the last radio broadcast list in the radio broadcast database 241 in step S370, step S380 may be performed. The second broadcast setting unit 220 may access an address of at least one radio streaming website stored in the radio broadcast database 241 to sequentially acquire listenable radio streams, and/or access a preset website to acquire an address of a radio streaming site stored in the preset website, and access the address of the radio streaming website to sequentially acquire listenable radio streams. In step S380, the second broadcast setting unit 220 may sequentially determine whether there is an audio signal of an audible radio stream having an audio signal similar to the first audio signal. In this case, if there is the audio signal of the audible radio stream having an audio signal similar to the first audio signal, the second broadcast setting unit 220 may add information (e.g., broadcast information) of radio streaming broadcast (e.g., the audible radio stream) to the radio broadcast database 241 in association with the frequency of the first broadcast, as a single entry.

FIG. 3B shows an example of a flowchart showing a radio broadcast database management method according to another example of the present disclosure.

FIG. 3B relates to a radio broadcast database management method if the first broadcast setting unit 210 is the first example. FIG. 3B shows an example of a diagram showing a case in which steps S310, S320, and S330 of FIG. 3A are replaced with a first process in step S31 and a second process in step S32.

As shown in FIG. 3B, a method of the present disclosure proceeds the first process in step S31, in which the first broadcast setting unit 210 may set the frequency of the first broadcast using the first tuner 201. The second process in step S32 comprises determining whether the information on the frequency of the first broadcast is present in the radio broadcast database 241. The third process in step S340 based on a result of performing the second process in S32.

In step S32, if it is determined that the information on the frequency of the first broadcast is present in the radio broadcast database 241, step S31 may be performed.

In step S32, if the information on the frequency of the first broadcast is present in the radio broadcast database 241, step S340 may be performed.

The second broadcast setting unit 220 may identify the radio broadcast list stored in the radio broadcast database 241 to recognize each broadcast in the radio broadcast list as the second broadcast of which broadcast information exists.

For example, in step 340, the second broadcast setting unit 220 may sequentially set the frequency of the second broadcast in the radio broadcast list in the second tuner 202.

The audio signal comparison unit 230 may receive the first audio signal of the first broadcast from the antenna connected to the first tuner 201, receive the second audio signal of the second broadcast from the antenna connected to the second tuner 202.

In step S350, the audio signal comparison unit 230 may compare the first audio signal with the second audio signal, and check whether the first audio signal and the second audio signal are similar to each other.

If it is determined in step S350 that the first audio signal and the second audio signal are similar to each other, step S360 may be performed. For example, in step S360, the broadcast information provision unit 240 may acquire the second broadcast information of the radio broadcast list related to the second broadcast from the radio broadcast database 241, and display the second broadcast information on a user screen (e.g., user interface, mobility device's screen, etc.) as the first broadcast information related to the first broadcast, and store the first broadcast information in the radio broadcast database 241. For example, the broadcast information provision unit 240 may store (or update) the radio database 241 with the broadcast name based on the region and frequency where the broadcast information provision unit 240 is located.

After step S360 is performed, a method of the present disclosure proceeds to step S310 in which a next listenable broadcast (e.g., listenable broadcast for broadcast information collection) may be sequentially acquired.

If it is determined in step S350 that the first audio signal and the second audio signal are not similar to each other, step S370 may be performed. For example, in step S370, a method of the present disclosure determines whether an audio signal (e.g., a current second audio signal) corresponds to a last radio broadcast list in the radio broadcast database 241.

In step S370, if the audio signal (E.g., the current second audio signal) does not correspond to the last radio broadcast list in the radio broadcast database 241, a method of the present disclosure proceeds to step S340 in which a process of acquiring the next radio broadcast list in the radio broadcast database 241 and setting a frequency of which broadcast information exists in the second tuner 202 is performed.

In step S370, if the current second audio signal corresponds to the last radio broadcast list in the radio broadcast database 241 in step S370, step S380 may be performed. The second broadcast setting unit 220 may access an address of at least one radio streaming website stored in the radio broadcast database 241 to sequentially acquire listenable radio streams, and/or access a preset website to acquire an address of a radio streaming site stored in the preset website, and access the address of the radio streaming website to sequentially acquire listenable radio streams. In step S380, the second broadcast setting unit 220 may sequentially determine whether or not there is an audio signal of an audible radio stream having an audio signal similar to the first audio signal. In this case, if there is the audio signal of the audible radio stream having an audio signal similar to the first audio signal, the second broadcast setting unit 220 may add information (e.g., broadcast information) of radio streaming broadcast (e.g., the audible radio stream) to the radio broadcast database 241 in association with the frequency of the first broadcast, as a single entry.

An example of the present disclosure provides an apparatus for managing radio broadcast database comprising: a first broadcast setting unit configured to set a frequency of a first broadcast using a first tuner; a second broadcast setting unit configured to set a frequency of a second broadcast of which broadcast information exists, using a second tuner; an audio signal comparison unit configured to receive a first audio signal of the first broadcast and a second audio signal of the second broadcast, and check whether the first audio signal and the second audio signal are similar to each other; and a broadcast information provision unit configured to acquire second broadcast information related to the second broadcast and store the second broadcast information as first broadcast information related to the first broadcast in a radio broadcast database, if it is determined that the first audio signal and the second audio signal are similar to each other.

Another example of the present disclosure provides a method for managing radio broadcast database comprising: a first broadcast setting step of setting a frequency of a first broadcast using a first tuner; a second broadcast setting step of setting a frequency of a second broadcast of which broadcast information exists, using a second tuner; an audio signal comparison step of receiving a first audio signal of the first broadcast and a second audio signal of the second broadcast, and checking whether the first audio signal and the second audio signal are similar to each other; and a broadcast information provision step of acquiring second broadcast information related to the second broadcast if it is determined that the first audio signal and the second audio signal are similar to each other, and storing the second broadcast information as first broadcast information related to the first broadcast in a radio broadcast database.

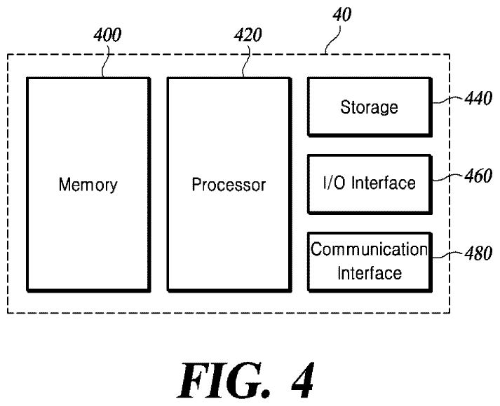

FIG. 4 shows an example of a block diagram schematically showing an example computing device that may be used to implement the method or device according to examples of the present disclosure.

A computing device 40 may include some or all of a memory 400, a processor 420, a storage 440, an input and output (I/O) interface 460, and a communication interface 480. The computing device 40 may be a stationary computing device such as a desktop computer, a server, or an AI accelerator, or a mobile computing device such as a laptop computer or a smart phone.

The memory 400 may store a program that allows the processor 420 to perform methods or operations according to various examples of the present disclosure. For example, the program may include a plurality of instructions that are executable by the processor 420. The method shown in FIG. 3A and FIG. 3B may be performed by the plurality of instructions being executed by the processor 420.

The memory 400 may be a single memory or a plurality of memories. In this case, information required to perform methods or operations according to various examples of the present disclosure may be stored in the single memory or divided and stored in the plurality of memories. If the memory 400 is configured of the plurality of memories, the plurality of memories may be physically separated.

The memory 400 may include at least one of a volatile memory and a non-volatile memory. The volatile memory includes a static random access memory (SRAM), a dynamic random access memory (DRAM), or the like, and the non-volatile memory includes a flash memory.

The processor 420 may include at least one core capable of executing at least one instruction. The processor 420 may execute instructions stored in the memory 400. The processor 420 may be a single processor or a plurality of processors.

The storage 440 maintains stored data even if power supplied to the computing device 40 is cut off. For example, the storage 440 may include a non-volatile memory or may include a storage medium such as a magnetic tape, optical disc, or magnetic disk.

A program stored in the storage 440 may be loaded into the memory 400 before being executed by the processor 420. The storage 440 may store files created in a program language, and a program created from a file by a compiler or the like may be loaded into the memory 400. The storage 440 may store data to be processed by the processor 420 and/or data processed by the processor 420.

The I/O interface 460 may provide an interface with an input device such as a keyboard or mouse, and/or an output device such as a display device or printer. A user may trigger execution of a program in the processor 420 through the input device and/or check a processing result of the processor 420 through the output device.

The communication interface 480 may provide access to an external network. For example, the computing device 40 may communicate with another device via the communication interface 480.

At least some of the components described in the exemplary examples of the present disclosure may be implemented by a hardware element including at least one of a digital signal processor (DSP), a processor, a controller, an application-specific IC (ASIC), a programmable logic device (FPGA, or the like), and other electronic devices, or a combination thereof. Additionally, at least some of the functions or processes described in the exemplary examples may be implemented as software, and the software may be stored in a recording medium. At least some of the components, functions, and processes described in exemplary examples of the present disclosure may be implemented through a combination of hardware and software.

Methods according to exemplary examples of the disclosure may be written as programs executable on a computer and may also be implemented on various recording mediums, such as magnetic storage medium, optical readout medium, digital storage medium.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium) or a radio signal, for processing by a data processing device, e.g., a programmable processor, a computer, or the operation of a plurality of computers, or for controlling the operation of a plurality of computers.

Although this specification includes details of a number of specific implementations, they should not be understood as limiting any invention or the scope of what may be claimed, but rather as a description of features that may be peculiar to a particular example of the invention. Certain features described herein in the context of individual examples may be implemented in combination in a single example. Conversely, various features described in the context of a single example may also be implemented individually or in any suitable sub-combination in a plurality of examples. Further, while features may operate in a particular combination and may be initially described as claimed as such, one or more features of a claimed combination may be excluded from that combination in some instances, and the claimed combination may be changed to a sub-combination or variation of a sub-combination.

The examples of the invention disclosed herein and in the drawings are shown by way of illustration only and are not intended to limit the scope of the invention. That other modifications based on the technical ideas of the present invention may be practiced in addition to the examples disclosed herein will be apparent to one of ordinary skill in the art to which the present invention belongs.

The scope of protection of the examples herein shall be construed in accordance with the claims below, and all technical ideas within the scope thereof shall be construed to be included within the scope of the claims herein.

What is claimed is:

1. An apparatus comprising:
a plurality of tuners comprising a first tuner and a second tuner;
at least one signal processor coupled to the plurality of tuners; and
memory storing instructions that, when executed by the at least one signal processor, cause the apparatus to:
set, using the first tuner, a frequency of a first broadcast, wherein broadcast information of the first broadcast is absent;
set, using the second tuner, a frequency of a second broadcast, wherein broadcast information of the second broadcast is provided to the apparatus;
receive a first audio signal of the first broadcast and a second audio signal of the second broadcast;
determine a correlation between the first audio signal and the second audio signal; and
based on a determination that the correlation satisfies a threshold:
acquire second broadcast information related to the second broadcast; and
update, in a radio broadcast database associated with the apparatus, first broadcast information related to the first broadcast with the second broadcast information.

2. The apparatus of claim 1, wherein the instructions, when executed by the at least one signal processor, cause the apparatus to receive, via a user input, information on the frequency of the first broadcast.

3. The apparatus of claim 2, wherein the instructions, when executed by the at least one signal processor, cause the apparatus to set, based on information on the frequency of the first broadcast not present in the radio broadcast database, the frequency of the second broadcast.

4. The apparatus of claim 1, wherein the instructions, when executed by the at least one signal processor, cause the apparatus to:
acquire a frequency of an audible broadcast while changing the frequency set in the first tuner or the second tuner; and
set, based on information related to the frequency of the audible broadcast not present in the radio broadcast database, the frequency of the audible broadcast as the frequency of the first broadcast for the first tuner.

5. The apparatus of claim 1, wherein the instructions, when executed by the at least one signal processor, cause the apparatus to determine a radio broadcast stored in the radio broadcast database to be the second broadcast.

6. The apparatus of claim 5, wherein the instructions, when executed by the at least one signal processor, cause the apparatus to sequentially determine at least one radio broadcast stored in the radio broadcast database to be the second broadcast until a correlation between the first audio signal and an audio signal of one of the at least one radio broadcast satisfies the threshold.

7. The apparatus of claim 6, wherein the instructions, when executed by the at least one signal processor, cause the apparatus to, based on a correlation between the first audio signal and each of audio signals of radio broadcasts stored in the radio broadcast database not satisfying the threshold:
access, via a wireless connection, a radio streaming source;
sequentially receive, from the radio streaming source, at least one audible radio stream; and
determine a correlation between the first audio signal and each of audio signals of the at least one audible radio stream.

8. The apparatus of claim 7, wherein the instructions, when executed by the at least one signal processor, cause the apparatus to acquire broadcast information corresponding to a first radio stream from the radio streaming source, and wherein a correlation between the first audio signal and an audio signal of the first radio stream satisfies the threshold.

9. The apparatus of claim 1, wherein the instructions, when executed by the at least one signal processor, cause the apparatus to store, in the radio broadcast database, the first broadcast information in association with the frequency of the second broadcast.

10. A method performed by an apparatus of a vehicle, the method comprising:
setting, using a first tuner of a plurality of tuners of the apparatus, a frequency of a first broadcast, wherein broadcast information of the first broadcast is absent;
setting, using a second tuner of the plurality of tuners of the apparatus, a frequency of a second broadcast, wherein broadcast information of the second broadcast is provided to the apparatus;
receiving a first audio signal of the first broadcast and a second audio signal of the second broadcast;
determining a correlation between the first audio signal and the second audio signal; and
based on a determination that the correlation satisfies a threshold:
acquiring second broadcast information related to the second broadcast; and
updating, in a radio broadcast database associated with the apparatus, first broadcast information related to the first broadcast with the second broadcast information.

11. The method of claim 10, wherein the setting the frequency of the first broadcast comprises:
acquiring a frequency of an audible broadcast while changing the frequency set in the first tuner or the second tuner; and
setting, based on information related to the frequency of the audible broadcast not present in the radio broadcast database, the frequency of the audible broadcast as the frequency of the first broadcast for the first tuner.

12. The method of claim 10, wherein the setting the frequency of the second broadcast comprises determining a radio broadcast stored in the radio broadcast database to be the second broadcast.

13. The method of claim 12, wherein the setting the frequency of the second broadcast comprises sequentially determining at least one radio broadcast stored in the radio broadcast database to be the second broadcast until a correlation between the first audio signal and an audio signal of one of the at least one radio broadcast satisfies the threshold.

14. The method of claim 13, wherein the setting the frequency of the second broadcast comprises:
based on a correlation between the first audio signal and each of audio signals of radio broadcasts stored in the radio broadcast database not satisfying the threshold:
accessing, via a wireless connection, a radio streaming source;
sequentially receiving, from the radio streaming source, at least one audible radio stream; and
determining a correlation between the first audio signal and each of audio signals of the at least one audible radio stream.
